(19) United States
(12) Patent Application Publication
(10) Pub. No.: US 2013/0075564 A1
(43) Pub. Date: Mar. 28, 2013

(54) Screw clamp having pivotal anchoring board

(71) Applicant: Chih Feng Ho, Taipei (TW)

(72) Inventor: Chih Feng Ho, Taipei (TW)

(73) Assignee: Oxti Corporation

(21) Appl. No.: 13/200,261

(22) Filed: Sep. 22, 2011

(51) Int. Cl. F16B 2/12

(52) U.S. Cl. 248/316.4

(57) ABSTRACT

A screw clamp includes a seat secured to a carrier member, a follower attached to the carrier member, an anchoring board pivotally attached to the follower for allowing the carrier member and the anchoring board to be engaged through a tiny space beside an edge portion of a table plate, and a screw engaged in the seat and engaged with the follower for allowing the follower to be moved relative to the carrier member by rotating the screw relative to the seat and for allowing the anchoring board to be moved toward the seat with the screw, and for allowing the screw clamp to be easily actuated or operated by the user.

### BACKGROUND OF THE INVENTION

1. Field of the Invention

The present invention relates to a screw clamp or carrier or support device, and more particularly to a screw clamp or carrier or support device including an improved structure arranged for allowing the screw clamp or carrier or support device to be easily actuated or operated by the user, and including a pivotal anchoring board pivotal or rotatable relative to a carrier member for allowing the carrier member and the anchoring board to be engaged through a tiny space beside an edge portion of a table plate.

2. Description of the Prior Art

Typical screw clamps comprise a C-shaped clamp body, and a bolt or screw threaded and attached or mounted to one end of the clamp body and movable or adjustable toward the other end of the clamp body for attaching or mounting or securing or clamping the clamp body onto various supporting members or tables.

For example, U.S. Pat. No. 2,461,687 to Hopfeld, U.S. Pat. No. 3,269,766 to Gardner, U.S. Pat. No. 4,582,307 to Wang, U.S. Pat. No. 4,627,604 to Choi, U.S. Pat. No. 4,874,155 to Goul, U.S. Pat. No. 4,921,234 to Peterson, and U.S. Pat. No. 5,423,525 to Spainhower disclose several of the typical screw clamps each also comprising a bolt or screw threaded and attached or mounted to one end of the clamp body for clamping onto various supporting members or tables.

However, the clamp body may only be attached or mounted to the supporting members or tables, but may not be used to attach or support the other members or objects, such as the keyboards, the monitors or the like.

U.S. Pat. No. 6,394,403 to Hung, and U.S. Pat. No. 6,478,275 to Huang disclose the other typical screw clamps each also comprising a bolt or screw threaded and attached or mounted to the clamp body for clamping onto various supporting members or tables and for supporting the other members or objects, such as the keyboards, the monitors or the like.

However, the clamp body includes a solid and spatial structure that may not be folded to the compact folding structure and that may not be easily and quickly attached or mounted or secured or clamped onto various supporting members or tables. The users have to bend or squat lower than the supporting members or tables for actuating or operating or rotating or driving the screw or bolt.

The present invention has arisen to mitigate and/or obviate the afore-described disadvantages of the conventional screw clamps or carriers or support devices.

### SUMMARY OF THE INVENTION

The primary objective of the present invention is to provide a screw clamp including an improved structure arranged for allowing the screw clamp or carrier or support device to be easily actuated or operated by the user.

The other objective of the present invention is to provide a screw clamp including a pivotal anchoring board pivotal or rotatable relative to a carrier member for allowing the carrier member and the anchoring board to be engaged through a tiny space beside an edge portion of a table plate.

In accordance with one aspect of the invention, there is provided a screw clamp comprising a carrier member, a seat secured to the carrier member, a follower slidably attached to the carrier member, an anchoring board pivotally attached to the follower with a pivot axle for allowing the anchoring board to be pivoted relative to the carrier member between a folding and storing position where the anchoring board is pivoted toward and to engage with the carrier member and a working position where the anchoring board is perpendicular to the carrier member, and a screw rotatably engaged in the seat and threaded and engaged with the follower for allowing the follower to be moved relative to the carrier member by rotating the screw relative to the seat and for allowing the anchoring board to be moved toward the seat also by rotating the screw relative to the seat.

The carrier member includes two tracks for slidably engaging with the follower and for limiting the follower to slide along the carrier member. The seat includes two engaging sockets formed therein for engaging with the tracks of the carrier member and for anchoring the seat to the carrier member and for preventing the seat from being disengaged from the carrier member.

The follower includes two studs extended therefrom for engaging with the pivot axle and for attaching the pivot axle to the follower. The anchoring board includes two recesses formed therein for engaging with the studs of the follower.

The anchoring board includes a groove formed therein for engaging with the screw when the anchoring board is pivoted toward and to engage with the carrier member. The seat includes a through hole formed therein for engaging with the screw and includes a cavity formed therein and spaced from the through hole of the seat.

The seat includes a cover having an aperture formed therein and aligned with the cavity of the seat. The seat includes at least one anchoring depression formed therein, and the cover includes at least one latch extended therefrom for engaging with the anchoring depression of the seat and for anchoring and securing the cover to the seat.

A base plate may further be provided and attached to the carrier member and secured to the seat, and includes an orifice formed therein for engaging with the screw. The carrier member includes two tracks, and the base plate includes two engaging notches formed therein for engaging with the tracks of the carrier member and for anchoring the base plate to the carrier member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a screw clamp in accordance with the present invention;

FIG. 2 is a perspective view of the screw clamp;

FIG. 3 is a perspective view similar to FIG. 2, illustrating the operation of the screw clamp;

FIG. 4 is a side plan schematic view of the screw clamp, and

FIGS. 5, 6, 7 are side plan schematic views similar to FIG. 4, illustrating the operation of the screw clamp.

### DETAILED DESCRIPTION OF THE PREFERRED EMBODIMENT

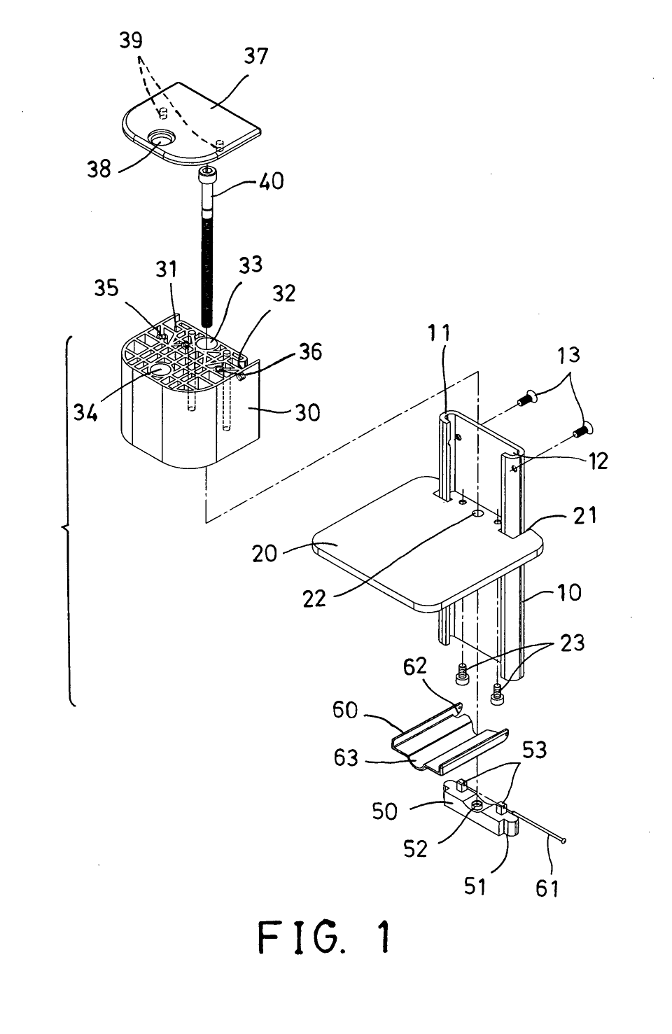

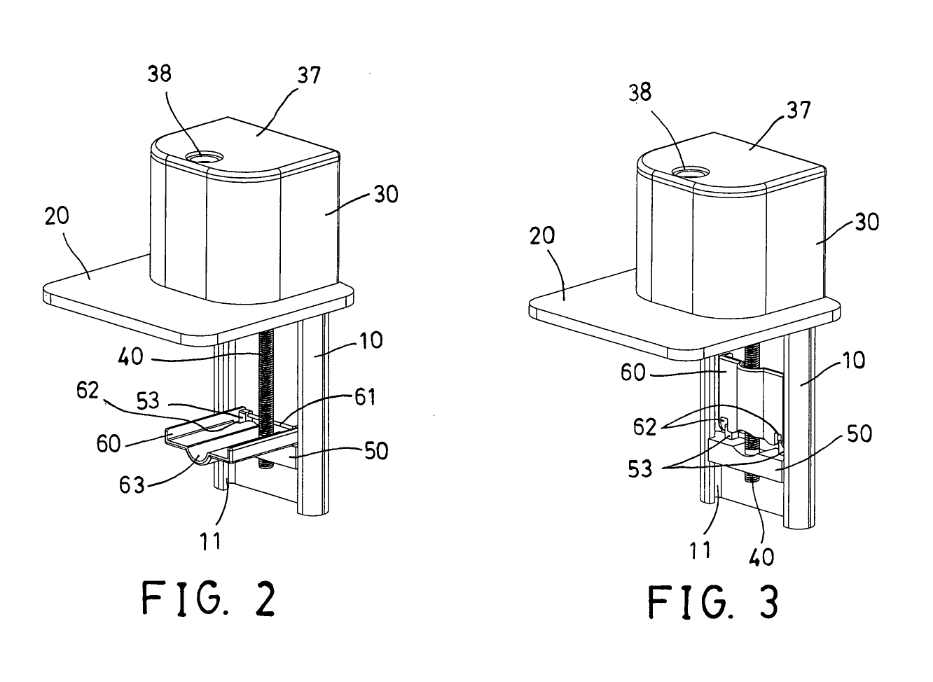

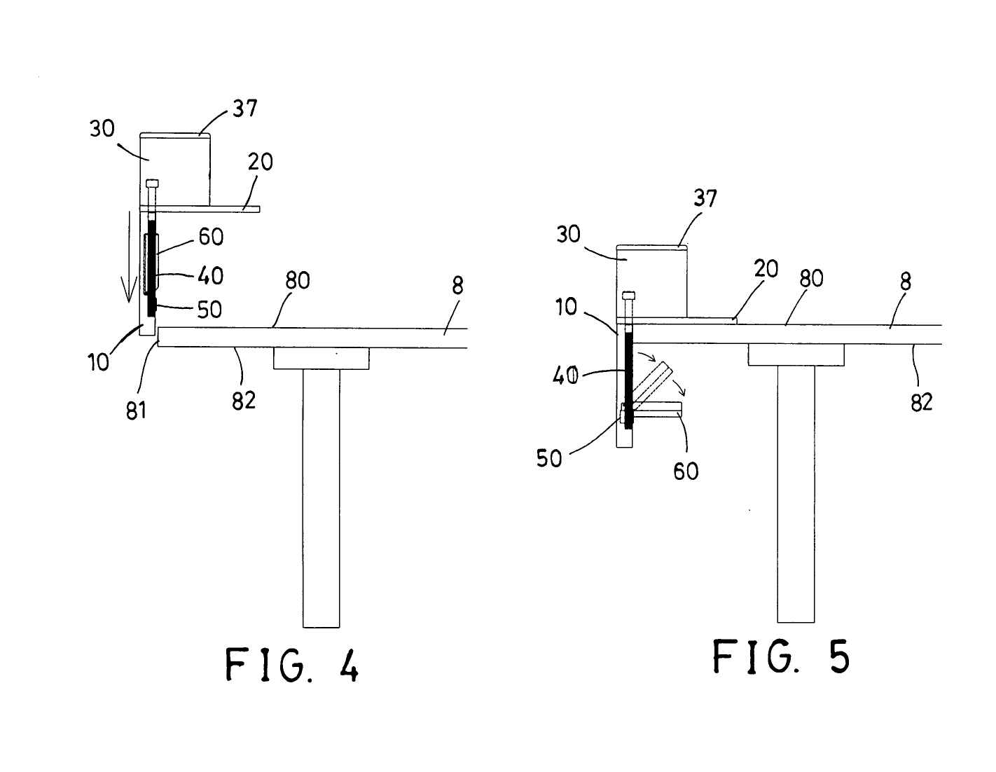

Referring to the drawings, and initially to FIGS. 1-4, a screw clamp in accordance with the present invention comprises a carrier or support plate or member 10 disposed or arranged perpendicular to a table top or table plate 8 (FIGS. 4-7) and to be attached or mounted or secured onto the table plate 8, and including one or more (such as two) side tracks 11, 12 oppositely formed therein, such as oppositely formed in the side portions thereof for forming a substantially C-shaped structure. A base plate 20 includes one or more (such as two) engaging notches 21 formed therein for engaging with the tracks 11, 12 of the carrier member 10 and for attaching or mounting or securing or coupling to the carrier member 10 and for being engaged onto and supported on the upper surface 80 of the table plate 8.

As best shown in FIGS. 4-7, the base plate 20 is substantially perpendicular to the carrier member 10 and to be engaged onto and supported on the upper surface 80 of the table plate 8, and the carrier member 10 is preferably engaged with the side or edge portion 81 of the table plate 8 for allowing the carrier member 10 and the base plate 20 to be solidly and stably engaged with and supported on the table plate 8. The base plate 20 includes an orifice 22 formed therein and disposed or located between the engaging notches 21 of the base plate 20 and also located between the tracks 11, 12 of the carrier member 10. The engagement of the tracks 11, 12 with the engaging notches 21 of the base plate 20 may limit the base plate 20 to slide up and down along and relative to the carrier member 10 and may prevent the base plate 20 from being disengaged from the carrier member 10.

A block or turret or seat 30 is disposed or engaged onto the base plate 20 and attached or mounted or secured onto the base plate 20 with one or more fasteners 23, it is preferable, but not necessarily that the fasteners 23 are disposed or located between the engaging notches 21 of the base plate 20 and also located between the tracks 11, 12 of the carrier member 10. It is also preferable, but not necessarily that the seat 30 includes one or more (such as two) engaging sockets 31, 32 formed therein for engaging with the tracks 11, 12 of the carrier member 10 and for attaching or mounting or securing or coupling to the carrier member 10. The seat 30 may further be solidly and stably attached or mounted or secured onto the carrier member 10 with one or more fasteners 13 for allowing the carrier member 10 and the base plate 20 and the seat 30 to be solidly and stably secured together.

The seat 30 includes a through hole 33 formed therein and disposed or located between the engaging sockets 31, 32 of the seat 30 for slidably receiving or engaging with a bolt or screw 40, and includes a cavity 34 formed therein and spaced from the through hole 33 of the seat 30, and includes one or more (such as two) anchoring depressions 35, 36 formed therein. A cover 37 includes an aperture 38 formed therein and aligned with the cavity 34 of the seat 30, and includes one or more (such as two) keys or pegs or latches 39 extended outwardly therefrom for engaging with the anchoring depressions 35, 36 of the seat 30 and for solidly and stably attaching or mounting or securing or anchoring to the seat 30. The aperture 38 of the cover 37 and the cavity 34 of the seat 30 may be used for plugging or inserting or engaging with various members or objects 88 (FIG. 7), such as the keyboards, the monitors 88, the lamps, the antenna members or the like.

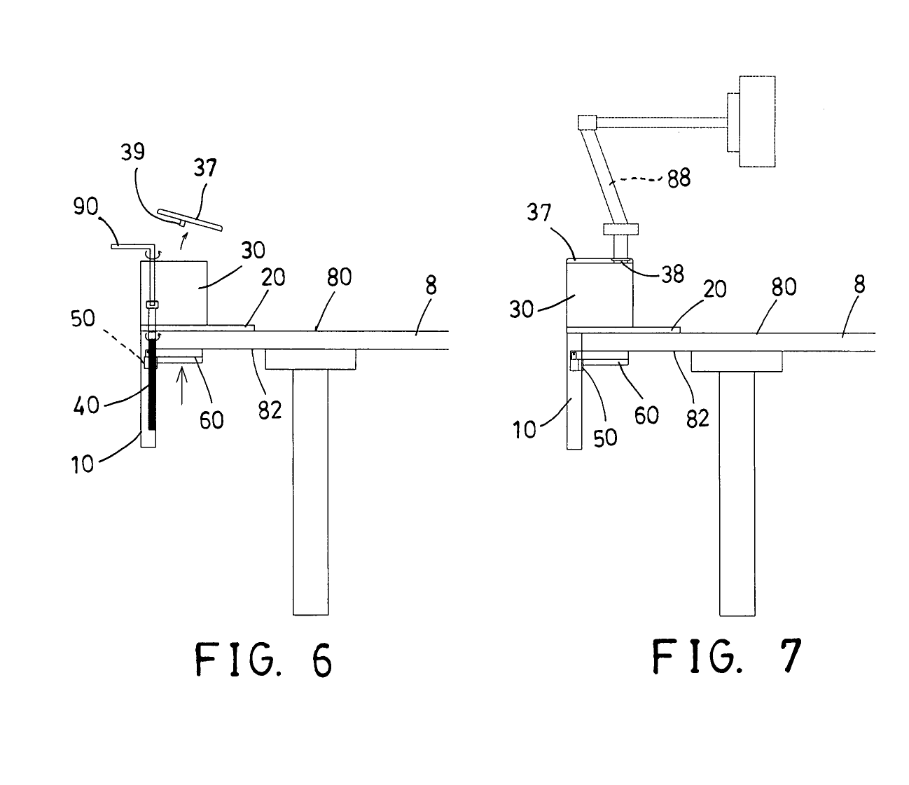

A follower 50 includes two side portions 51 for slidably receiving or engaging with the tracks 11, 12 of the carrier member 10 and for limiting the follower 50 to slide up and down along and relative to the carrier member 10 and may prevent the base plate 20 from being disengaged from the carrier member 10, and includes a screw hole 52 formed therein for threading or engaging with the screw 40, and the screw 40 is pivotally or rotatably engaged in the through hole 33 of the seat 30 and rotatably engaged through the orifice 22 of the base plate 20 and threaded and engaged with the screw hole 52 of the follower 50 for allowing the follower 50 to be moved or slid up and down along and relative to the carrier member 10 by rotating or driving the screw 40 relative to the seat 30 with such as a driving tool 90 (FIG. 6).

A pivotal anchoring board 60 is pivotally or rotatably attached or mounted or secured or engaged with the follower 50 with a pivot axle 61, for example, the follower 50 includes one or more (such as two) pegs or protrusions or studs 53 extended outwardly therefrom for engaging with the pivot axle 61 and for solidly and stably attaching or mounting or securing or anchoring the pivot axle 61 to the follower 50, and the pivotal anchoring board 60 includes one or more (such as two) notches or recesses 62 formed therein for receiving or engaging with the studs 53 of the follower 50 for allowing the anchoring board 60 to be pivotally or rotatably attached or mounted or secured or engaged with the follower 50. It is preferable, but not necessarily that the anchoring board 60 includes a channel or groove 63 formed therein for receiving or engaging with the screw 40 when the anchoring board 60 is pivoted or rotated upwardly toward and to engage with the carrier member 10 (FIGS. 4, 5).

In operation, as shown in FIGS. 4 and 5, the anchoring board 60 may first be pivoted or rotated upwardly toward and to engage with the carrier member 10 at a folding or storing position for allowing the carrier member 10 and the anchoring board 60 to be easily engaged through a tiny space beside the side or edge portion 81 of the table plate 8, and the anchoring board 60 may then be pivoted or rotated downwardly or away from the carrier member 10 to a working position where the anchoring board 60 is substantially perpendicular to the carrier member 10 and parallel to the base plate 20, for allowing the anchoring board 60 to be selectively engaged with the bottom surface 82 of the table plate 8, and for allowing the side or edge portion 81 of the table plate 8 to be received or engaged in or located between the base plate 20 and the anchoring board 60 (FIGS. 5, 6). The anchoring board 60 may then be caused to move toward base plate 20 or toward the bottom surface 82 of the table plate 8 and to clamp and secure the side or edge portion 81 of the table plate 8 between the base plate 20 and the anchoring board 60 with the screw 40.

It is to be noted that the anchoring board 60 may first be pivoted or rotated upwardly toward and to engage with the carrier member 10 at the folding or storing position for allowing the carrier member 10 and the anchoring board 60 to be easily and quickly and readily engaged through the tiny space beside the side or edge portion 81 of the table plate 8, and for allowing the base plate 20 and the anchoring board 60 to be easily and quickly and readily attached or mounted or secured to the side or edge portion 81 of the table plate 8 by rotating or driving the screw 40 relative to the seat 30 with the driving tool 90 that is disposed or located above the seat 30 such that the user is not required to bend or squat lower than the supporting members or table 8.

Accordingly, the screw clamp in accordance with the present invention includes an improved structure arranged for allowing the screw clamp or carrier or support device to be easily actuated or operated by the user, and includes a pivotal anchoring board pivotal or rotatable relative to a carrier member for allowing the carrier member and the anchoring board to be engaged through a tiny space beside an edge portion of a table plate.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw clamp comprising:
a carrier member,
a seat secured to said carrier member,
a follower slidably attached to said carrier member, an anchoring board pivotally attached to said follower with a pivot axle for allowing said anchoring board to be pivoted relative to said carrier member between a folding and storing position where said anchoring board is pivoted toward and to engage with said carrier member and a working position where said anchoring board is perpendicular to said carrier member, and
a screw rotatably engaged in said seat and threaded and engaged with said follower for allowing said follower to be moved relative to said carrier member by rotating said screw relative to said seat and for allowing said anchoring board to be moved toward said seat with said screw.

2. The screw clamp as claimed in claim 1, wherein said carrier member includes two tracks for slidably engaging with said follower and for limiting said follower to slide along said carrier member.

3. The screw clamp as claimed in claim 1, wherein said carrier member includes two tracks, and said seat includes two engaging sockets formed therein for engaging with said tracks of said carrier member and for anchoring said seat to said carrier member.

4. The screw clamp as claimed in claim 1, wherein said follower includes two studs extended therefrom for engaging with said pivot axle and for attaching said pivot axle to said follower.

5. The screw clamp as claimed in claim 4, wherein said anchoring board includes two recesses formed therein for engaging with said studs of said follower.

6. The screw clamp as claimed in claim 1, wherein said anchoring board includes a groove formed therein for engaging with said screw when said anchoring board is pivoted toward and to engage with said carrier member.

7. The screw clamp as claimed in claim 1, wherein said seat includes a through hole formed therein for engaging with said screw and includes a cavity formed therein and spaced from said through hole of said seat.

8. The screw clamp as claimed in claim 7, wherein said seat includes a cover having an aperture formed therein and aligned with said cavity of said seat.

9. The screw clamp as claimed in claim 8, wherein said seat includes at least one anchoring depression formed therein, and said cover includes at least one latch extended therefrom for engaging with said at least one anchoring depression of said seat and for anchoring said cover to said seat.

10. The screw clamp as claimed in claim 1, wherein a base plate is attached to said carrier member and secured to said seat, and includes an orifice formed therein for engaging with said screw.

11. The screw clamp as claimed in claim 10, wherein said carrier member includes two tracks, and said base plate includes two engaging notches formed therein for engaging with said tracks of said carrier member and for anchoring said base plate to said carrier member.
